(19) United States
(12) Patent Application Publication
(10) Pub. No.: US 2026/0206997 A1
(43) Pub. Date: Jul. 23, 2026

(54) BEVERAGE MACHINE, BEVERAGE TABLET, AND METHOD OF FORMING A BEVERAGE

(71) Applicant: Keurig Green Mountain, Inc., Burlington, MA (US)

(72) Inventors: Matthew James Maille, Essex Junction, VT (US); Jordan Cormier, Shirley, MA (US)

(73) Assignee: Keurig Green Mountain, Inc., Burlington, MA (US)

(21) Appl. No.: 19/133,638

(22) PCT Filed: Dec. 1, 2023
(86) PCT No.: PCT/US2023/082098

§ 371 Date: May 28, 2025

Related U.S. Application Data
(60) Provisional application No. 63/429,968, filed on Dec. 2, 2022.

(51) Int. Cl. A47J 31/36; A23F 3/32; A23F 5/12; A47J 31/41; A47J 31/52

(52) U.S. Cl. CPC A47J 31/36; A23F 3/32; A23F 5/125; A47J 31/41; A47J 31/52

(57) ABSTRACT

Aspects described herein relate to improvements in beverage machines and methods of brewing beverages therein. According to some embodiments, a beverage tablet includes one or more voids configured to physically interact with one or more contact pins of a beverage machine. The interaction between the tablet of beverage material and the beverage machine may physically configure mechanical flow controls that establish the parameters for brewing the beverage specific to the composition of the tablet.

### CROSS REFERENCE TO RELATED APPLICATION

This application claims the benefit of U.S. Provisional Application No. 63/429,968, filed Dec. 2, 2022, which is hereby incorporated by reference in its entirety.

### FIELD

The present disclosure relates generally to a beverage machine, a beverage tablet configured to interact with the beverage machine to form a beverage, and methods of forming a beverage.

### BACKGROUND

Beverage machines are widely used to make beverages using capsules that contain ingredients, such as coffee grounds, tea leaves, and/or other soluble and/or insoluble ingredients. Such beverage machines can often be used with capsules containing a wide variety of different ingredients so as to make different beverages, such as coffee, tea, hot chocolate, flavored still drinks, flavored carbonated drinks, and so on.

### SUMMARY

According to one aspect, a beverage machine comprises a brew chamber configured to receive a beverage tablet comprising beverage ingredients, and at least one contact pin. The at least one contact pin is configured to physically contact the beverage tablet. The at least one contact pin is moveable relative to the brew chamber such that contact between the contact pin and the tablet causes the at least one contact pin to move a displacement distance relative to the brew chamber. The beverage machine further comprises at least one fluid port configured to introduce fluid from a liquid supply into the brew chamber. The displacement distance moved by the at least one contact pin due to contact between the at least one contact pin and the beverage tablet mechanically sets a fluid flow rate from the at least one fluid port.

According to another aspect, a beverage tablet comprises a first end of the beverage tablet a second end of the beverage tablet displaced by the first end by a thickness. The beverage tablet comprises a blind hole having a depth extending from the first end of the beverage tablet toward the second end of the beverage tablet only partially through the thickness. The blind hole has an interior contact surface configured to abut against a contact pin of a beverage machine.

According to another aspect, a beverage forming arrangement comprises a beverage machine and a beverage tablet comprising a blind hole having a depth extending only partially through a thickness of the beverage tablet. The blind hole has an interior contact surface configured to abut against a contact pin of the beverage machine. The depth of the blind hole determines a displacement distance of the contact pin during abutment of the interior contact surface against the contact pin. The displacement distance moved by the contact pin mechanically sets a fluid flow rate from at least one fluid port of the beverage machine.

According to one aspect, a method of forming a beverage is provided. The method comprises inserting a beverage tablet into a beverage machine, bringing at least one contact pin of the beverage machine into contact with the beverage tablet. Contact with the beverage tablet causes the at least one contact pin to move a displacement distance. The displacement distance moved by the at least one contact pin mechanically sets a fluid flow rate from at least one fluid port of the beverage machine. The method further comprises actuating the beverage machine to output liquid through the at least one fluid port at the fluid flow rate into contact with the beverage machine to form a beverage.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is an interior facing perspective view of a beverage machine brew chamber holding a beverage tablet;

FIG. 2 is a perspective view of one embodiment of a beverage tablet;

FIG. 3 is a cross-sectional view of a portion of a beverage tablet interacting with a contact pin and flow control valve of a beverage machine;

FIG. 4A is a cross-sectional view of a first beverage tablet interacting with a contact pin and a flow control valve of a beverage machine;

FIG. 4B is a cross-sectional view of a second beverage tablet interacting with a contact pin and a flow control valve of a beverage machine;

FIG. 4C is a cross-sectional view of a third beverage tablet interacting with a contact pin and a flow control valve of a beverage machine;

FIG. 5 is a cross-sectional view of one embodiment of a beverage tablet interacting with a contact pin, fluid port, and flow control valve of a beverage machine;

FIG. 6 is a cross-sectional view of a tablet positioned within a brew chamber of a beverage machine;

FIG. 7A is a cross-sectional view of a first beverage tablet interacting with a conduit-type contact pin of a beverage machine;

FIG. 7B is a cross-sectional view of a second beverage tablet interacting with a conduit-type contact pin of a beverage machine;

FIG. 7C is a cross-sectional view of a third beverage tablet interacting with a conduit-type contact pin of a beverage machine;

FIG. 8A is a cross-sectional view of a first beverage tablet interacting with a conduit-type contact pin of a beverage machine;

FIG. 8B is a cross-sectional view of a second beverage tablet interacting with a conduit-type contact pin of a beverage machine;

FIG. 8C is a cross-sectional view of a third beverage tablet interacting with a conduit-type contact pin of a beverage machine;

FIG. 9 is a cross-sectional view showing fluid discharging from one embodiment of a conduit-type contact pin;

FIG. 10 is a cross sectional view showing fluid discharging from a second embodiment of conduit-type contact pin;

FIG. 11 is a drawing of an embodiment of a tablet showing lines of potential fracture; and

FIG. 12 is a schematic diagram of components of a beverage machine in an illustrative embodiment.

### DETAILED DESCRIPTION

It should be understood that aspects of the invention are described herein with reference to the figures, which show illustrative embodiments. The illustrative embodiments described herein are not necessarily intended to show all embodiments in accordance with the invention, but rather are used to describe a few illustrative embodiments. Thus, aspects of the invention are not intended to be construed narrowly in view of the illustrative embodiments. In addition, it should be understood that aspects of the invention may be used alone or in any suitable combination with other aspects of the invention.

A beverage machine may be used to form a beverage by combining a beverage precursor liquid with a beverage ingredient. Single serving or small batch beverage machines are popular in the market. These beverage machines allow a user to prepare a small quantity of a beverage such as a single serving or a small batch of beverage. Multiple users can use the same machine to prepare different beverages, such as individual servings of different beverage types or beverage flavors quickly and without wasting unconsumed beverage.

A single serving or small batch beverage machine may be used with a consumable comprising a single serving or small batch serving of beverage ingredients to form a beverage such as tea, coffee, espresso, cocoa or other infusion type beverages. The consumable may include beverage ingredients such as suitably prepared coffee beans, tea leaves, etc. The beverage machine may form such beverages using a beverage precursor liquid, such as water, that may be combined with the beverage ingredients of the consumable under suitable conditions to form the beverage.

Conventional beverage ingredient consumables are typically individually packaged servings of beverage ingredients, such as suitably ground coffee, to be combined with liquid and brewed. These individual packages of beverage ingredients may then be disposed after the beverage has been prepared.

The inventors have recognized and appreciated improvements in beverage machines, beverage ingredients packaging and methods of preparing a beverage. These improvements may reduce beverage ingredients packaging and/or waste resulting from the preparation of a beverage. Beverage ingredients may be portioned for use within a beverage machine without separate disposable packaging for each portion according to some embodiments disclosed herein.

According to some aspects discussed herein, a beverage ingredient consumable may be provided in the form of a beverage tablet. In some embodiments, the beverage ingredients of the beverage tablet have been compacted to form the tablet. The beverage tablet may be able to hold its own shape, and thus may not require individual packaging to prevent dispersing of the beverage ingredients prior to use in forming a beverage. In some embodiments, the tablet may be bound together with a food-grade binder or with another beverage ingredient that promotes formation of the beverage tablet into a cohesive structure. Some beverage tablets may be formed through processing alone, such as by pressing, heating, or drying into the desired form.

A beverage machine may be capable of forming a variety of beverages, each having specific brew parameters such as quantity of beverage precursor liquid, brewing time, liquid flow rate, brewing temperature, brewing pressure, presence of a vapor phase such as steam or air, or other parameters. It may be desirable for a beverage machine to have the capability of adjusting one or more brew parameters for a beverage without requiring a user to manually set one or more of such parameters.

In some embodiments, the physical interaction of the beverage tablet and the beverage machine sets one or more brewing parameters. One example of physical interaction includes tactile contact between the beverage tablet and the beverage machine.

In some embodiments, the physical interaction of the beverage tablet and the beverage machine mechanically changes a physical characteristic of the beverage machine to set one or more brewing parameters. One example of physical interaction includes tactile contact between the beverage tablet and the beverage machine. Examples of changes in a physical characteristic of the beverage machine include changes to the flow area of one or more fluid ports through which a beverage precursor liquid flows, adjustments to flow valves, metering devices, or any other suitable component.

Such changes may be achieved purely mechanically by physical interaction of the beverage tablet and beverage machine without involvement from any type of electronic actuation, electronic controller, or electronic processor.

Changes in a physical characteristic of the beverage machine may impact brew parameters for the brewing process. Brew parameters may include a beverage volume, temperature, beverage strength, beverage formation time, carbonation level, etc. Adjusting a “strength” of a beverage may be performed in different ways, such as adjusting the amount of beverage precursor liquid used to form the beverage, adjusting the liquid or steam pressure used to form the beverage, adjusting flow rate, adjusting temperature, adjusting brew time, and other ways. For instance, adjusting the “strength” of a beverage may be done by adjusting a flow rate of water to the beverage tablet such that a slower flow rate provides longer contact time between beverage precursor liquid and beverage ingredients, thereby increasing a “strength” of the beverage dispensed. A fluid may be heated or cooled prior to brewing the beverage, heated and then cooled, or cooled and then heated as required by the brewing process.

While in some embodiments, changes in brewing parameters may be achieved purely mechanically, it should be appreciated that, in other embodiments, a beverage machine may use electronic actuation, sensors, electronic controllers, or electronic processors, to change one or more brewing parameters based on physical interaction of the beverage tablet and beverage machine as this aspect is not so limited. For example, the distance of how far a contact pin of the beverage machine is pushed back due to contact with the beverage tablet may be detected by a controller, and the controller may change one or more brewing parameters based on that detected distance.

In some embodiments, a beverage consumable is provided in the form of a beverage tablet. In some embodiments, the beverage ingredients of the beverage tablet may directly contact a beverage machine without intervening packaging containing the beverage ingredients of the beverage tablet. However, it should be appreciated that, in other embodiments, the beverage tablet may be in different forms. For example, in some embodiments, a beverage tablet may comprise loose beverage ingredients with packaging used to contain the loose beverage ingredients.

In some embodiments, a package-less beverage consumable (e.g., a beverage tablet) may include a shell, such as a coating, disposed along the outer surface at the periphery of the consumable. In some embodiments, the shell may bind the beverage ingredients within the interior of the consumable. The beverage ingredients within the consumable may be loose, such as loose ground coffee, or compacted. The shell may be a food grade binder, an alginate, edible, soluble, or any other suitable material. In some embodiments, the shell may serve as a barrier to reduce infiltration of oxygen and/or moisture such as to maintain freshness of the beverage ingredients. Material of the package-less beverage consumable, including a shell of the consumable if one is present, may directly contact some portion of the beverage machine, such as the brew chamber, before brewing the beverage, without intervening packaging in-between.

A package-less beverage consumable (e.g., a beverage tablet) may be configured to break into pieces during brewing or it may be configured to remain intact during brewing. The package-less beverage consumable may be configured to at least partially or completely dissolve. In some embodiments, the package-less beverage consumable may contain roasted coffee grounds (e.g. that remain behind after forming a beverage), soluble coffee, soluble materials, binders or other materials, and any combination of the above. The package-less beverage consumable may be any suitable shape, such as a cylinder, a sphere, an ellipsoid, an elliptical prism, a teardrop shape, a frustrum of a cone, a cone or other shape.

A beverage tablet may be used to form a beverage such as tea, coffee, espresso, cocoa or other beverages prepared from a powder, dry concentrate or dry beverage material such as suitably prepared coffee beans, tea leaves etc. The beverage machine may form such beverages using a base liquid, such as water, that may be combined with the beverage material under suitable conditions to form the beverage.

In some embodiments, a beverage tablet may have a body and an outer wall, where the body and/or the outer wall are made of one or more beverage ingredients. Examples of beverage ingredients include, but are not limited to: coffee (e.g., coffee grounds, soluble coffee), tea (e.g. tea leaves, dry herbal tea), powdered beverage concentrate, dried fruit extract or powder, powdered or liquid concentrated bouillon or other soup, powdered or liquid medicinal materials (e.g. nutraceuticals), powdered milk or other creamers, sweeteners, thickeners, flavorings, binding agents, coating agents, cellulose, chaff, filter aids, extracts, plant husks, plant fibers, bagasse, additives, or any other type of food. Examples of filter aids include, but are not limited to, perlite, diatomaceous earth, diatomite, chaff, and cellulose. Examples of binding agents include, but are not limited to, cellulose, cellulose derivatives, gelatin, cream, honey, starch, sucrose, mannitol, liquid glucose, and zein.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

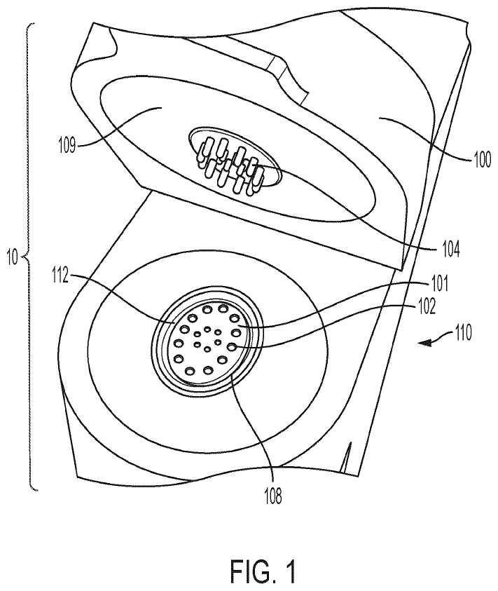

FIG. 1 shows a beverage machine and beverage tablet according to one embodiment. The combination of beverage machine 100 and beverage tablet 101 comprises a beverage forming arrangement 10. In the embodiment of FIG. 1, the beverage tablet is provided in the form of a compacted beverage tablet, although it should be appreciated that a beverage tablet may be provided in other forms. Beverage machine 100 may further include a tablet holder comprising a brew chamber 110, which includes a space 112 configured to receive the beverage tablet 101. In some embodiments, the brew chamber 110 may include a brew chamber receptacle 108 and a brew chamber lid 109. The brew chamber lid 109 may have a closed position and an open position. In the open position, the brew chamber lid 109 may be configured to allow a user to insert the beverage tablet 101 into the brew chamber receptacle 108. In the closed position, the brew chamber lid 109 may cover the brew chamber receptacle 108 to define the space 112.

It should be appreciated that while the lid is on the upper portion of the brew chamber in the illustrated embodiment, brew chambers with lids at other positions on the brew chamber are contemplated. For example, a brew chamber may open horizontally such that a brew chamber lid is located on a side of the brew chamber.

In some embodiments, a beverage machine may include one or more contact pins 104 that interact with a beverage tablet. In some embodiments, a beverage tablet, such as a compacted beverage tablet, may include one or more voids that the posts interact with. The contact pins may be received within the voids to align the beverage tablet. The voids may be blind holes that pass only partially through the depth of the tablet and/or through-holes that pass completely through the depth of the tablet. Some beverage tablets may have both through-holes and blind holes. The one or more contact pins may be located on the brew chamber lid, in the brew chamber receptacle, or both.

In the illustrative embodiment of FIG. 1, contact pins 104 located on the brew chamber lid 109 are configured to interact with voids 102 on a beverage tablet 101 located in a brew chamber receptacle 108. The voids 102 shown in FIG. 1 are blind holes. However, it should be appreciated that in other embodiments, one or more of the voids 102 may be through-holes.

Contact pins may be located on other surfaces within the brew chamber with other orientations. Contact pins may be operably coupled to flow control valves or fluid metering components of the beverage machine. In some embodiments, the contact pins may comprise fluid ports such as nozzles to deliver liquid and other fluids into the brew chamber during brewing or preparation of the beverage. In some embodiments, fluid ports may be arranged around the contact pins such that the contact pin extends at least partially through an interior of the fluid port. In some embodiments, the upstream end of the contact pin may be connected to, or be unitary with, the flow control valve. In other embodiments, fluid may be introduced into the brew chamber from one or more fluid ports or orifices located elsewhere in the brew chamber such that a contact pin, and the fluid port controlled by the contact pin, may be located in different areas of the brew chamber. In some embodiments, fluid ports may be spaced apart from the contact pins such that the fluid ports are not integrated with the contact pins, but rather two separate components.

In some embodiments, contact pins may also serve to intentionally fracture the beverage tablet during a brewing process.

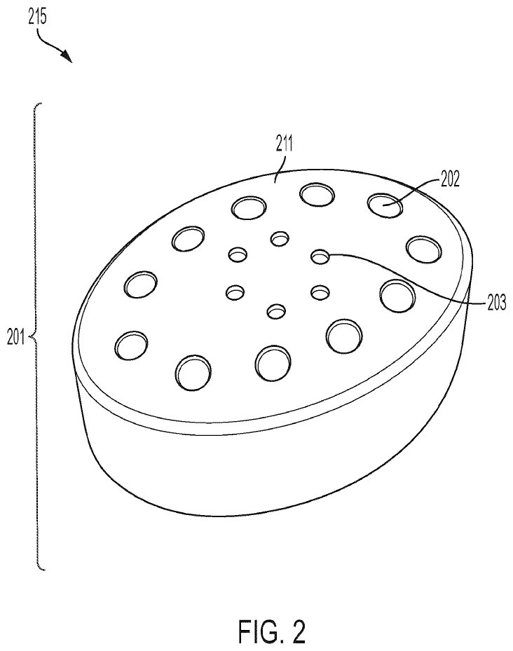

FIG. 2 shows a representative image of a beverage tablet 201 in the form of a compacted beverage tablet. The body of the beverage tablet is made of ingredients 211 that have been compacted into a tablet form. The tablet may include a plurality of voids. As illustrated, the voids include an outer group of voids 202 and an inner ring of voids 203. It should be understood that this example is provided for illustrative purposes only and other patterns of voids including more or fewer voids, and voids of different shape or diameter are contemplated. In some embodiments, the voids may be blind holes. In some embodiments, the voids may be through-holes. In some embodiments, the tablet may have voids on more than one side and in any suitable arrangement. The voids are configured to receive contact pins which may move a displacement distance due to interaction with the voids.

As illustrated in FIG. 2, the beverage tablet has an elliptic cylinder shape, but other shapes are contemplated. In some embodiments, the beverage tablet may be a cylinder, a rectangular prism, a sphere, or any other shape.

In some embodiments, the beverage tablet may be shaped to guide insertion of the tablet into the brew chamber, such as for instance to allow the beverage tablet to be inserted into the brew chamber in only one orientation. This may be accomplished by patterns, asymmetrical features or any other suitable way including additional posts or notches on the tablet and/or on the beverage machine to prevent incorrect insertion of the tablet.

The tablet may include identifying information for a user. Such information may include the manufacturer's name or logo as well as the type of beverage material, expiration dates, nutritional information, warnings, or other information. This information may be for the user's benefit and may not serve any role in the configuration of the machine or in the brewing process. In other embodiments text may provide instructions to the user but not to the beverage machine itself, examples include “This Side Up” or similar markings.

Additional brew parameters may include the degree of intended break-up of the tablet. The tablet may be broken up by rotation or translation of a set of pins, which may be the same or different from the contact pins, or from another structure included to break-up the tablet. The brew parameters may include a break-up force or torque to be applied to the tablet or a number of rotations or translation distance to be applied to a tablet through a break-up structure. Information on such parameters may be encoded in voids or geometry of the tablet as with the flow parameters previously described. Mechanical interaction between the beverage machine and the encoded features may configure the beverage machine to break-up the tablet during brewing.

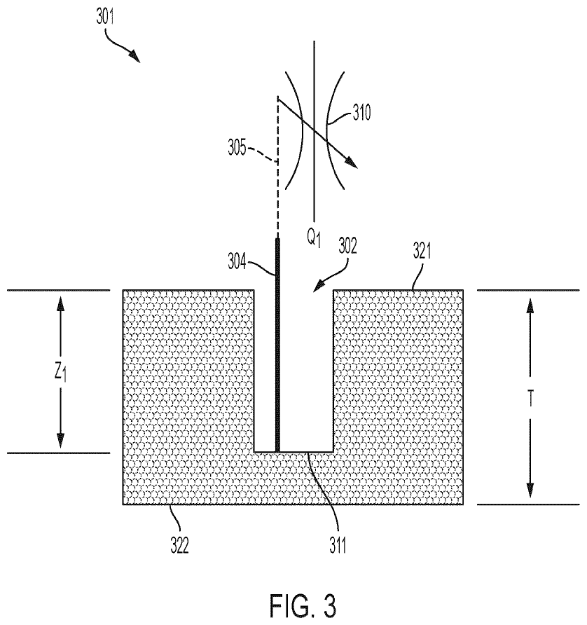

FIG. 3 depicts an illustrative schematic of a beverage tablet interacting with a contact pin of a beverage machine to result in mechanical flow control. The tablet 301 includes a first end 321, and a second end 322, where the second end 322 is displaced by the first end 321 by a thickness T. The tablet 301 includes a void 302 in the form of a blind hole having a depth Z₁ that extends only partially through the thickness T of the beverage tablet. A contact pin 304 of a beverage machine enters the void 302 and contacts an interior bottom surface 311 of the void 302. The depth of the void may thus dictate a displacement distance of the contact pin.

A single beverage tablet may have a plurality of voids with the same depths or different depths. Two beverage tablets may have voids of different depths.

In some embodiments, the brew chamber lid may abut a face of the tablet onto which the contact pin voids are disposed so that distance Z₁ may be with respect to the brew chamber lid. In some embodiments, the location of the contact pin is communicated by a mechanical linkage 305 to a variable flow control valve 310. Linkage 305 may be a solid linkage, a plurality of solid linkages including bellcranks, levers, sliders or other mechanical linkages or flexible linkages including chains, cables or pushrods. The flow control valve 310 may be configured to be moved by the linkage, such that the open area of the valve and/or the flow rate delivered from the valve is related to distance Z₁, the depth of the void. The flowrate delivered through the valve is Q₁. In some embodiments, the valve and linkage may be configured to deliver a greater flow rate (larger Q₁) when Z₁ is made smaller (shallower void) and in other embodiments, the valve and linkage may be configured to deliver a greater flow rate (larger Q₁) when Z₁ is made larger (deeper void). In some embodiments, a void in the form of a through-hole may result in no flow from the beverage machine. In other embodiments, a through-hole void may result in maximum flow from a fluid port. The direction of increasing flow should not be limiting in this disclosure.

In some embodiments, a contact pin is spring-loaded or otherwise biased toward a full extension length. Abutment of the contact pin against a contact surface, such as a surface of a beverage tablet, may cause the contact pin to move a displacement distance relative to its full extension length, and in doing so may cause a spring or other biasing element to compress. Removal of the contact surface (e.g. moving the beverage tablet out of contact with the contact pin), may then cause the contact pin to move back toward its full extension length.

In FIG. 3, the contact pin is shown to enter void 302 prior to the initiation of the brewing process. It may be recognized that the tablet may be intentionally fractured during brewing or it may be ablated or softened such that it may lose its mechanical integrity. In some embodiments, the contact pins may be configured to lock into their positions after initial contact with the tablet. In this way, the positions of the fluid metering valves would not change as a result of decomposition of the tablet. The pins may then release to their full extension length prior to insertion of the next tablet, such as at the conclusion of the brewing process or when brew chamber lid 109 (see FIG. 1) is opened. In other embodiments, one or more contact pins may be configured to remain mobile throughout brewing and may be configured to perform a timing and/or sensing function related to the brewing processes such as to terminate brewing when a certain part of the beverage tablet has dissolved, softened, etc.

In some embodiments, the contact pin may comprise a tube or other conduit and may be configured to deliver flow from a flow metering valve, such as from the flow metering valve that is positioned by that contact pin. The contact pin, linkage, and at least part of the flow metering valve may therefore be a single integrated component, or a rigidly assembled group of components. The fluid port may be at the tip or along a surface of the contact pin.

In some of these embodiments, flow may be received directly into the voids of the beverage tablet.

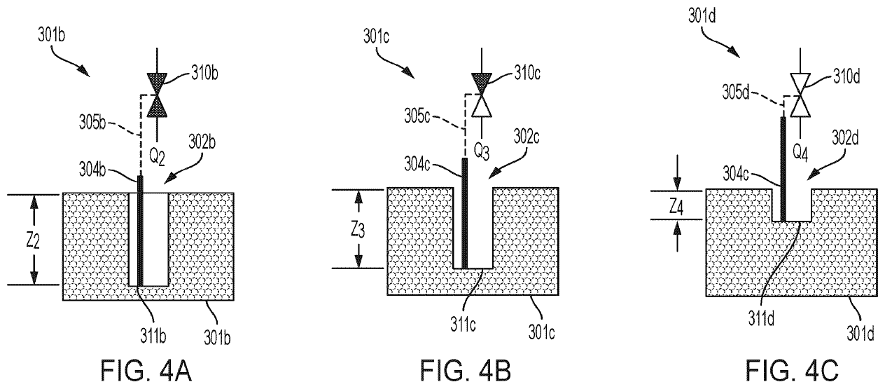

FIGS. 4A-4C illustrate three beverage tablets, each having a different void depth, and each interacting with a beverage machine. In this example, lower flowrates are associated with deeper voids, but the opposite configuration is also contemplated. As seen in FIG. 4A, a first beverage tablet 301b contains a void 302b. Contact pin 304b of a beverage machine enters void 302b. Here, the depth of void 302b is Z₂, which is greater than the maximum downward travel of contact pin 304b. As such, the contact pin 304b does not touch the interior bottom surface 311b of the void 302b. In this case, a flow metering valve 310b of the beverage machine remains closed as indicated in the figure. With the valve closed, the flow rate delivered Q₂, will be zero. In this embodiment, with a beverage tablet void depth greater than a certain distance, no flow will result from a beverage machine valve associated with that void. In some embodiments, a void in the form of a through-hole may produce the same no-flow result.

As seen in FIG. 4B, a second beverage tablet 301c contains a void 302c. Contact pin 304c of a beverage machine enters void 302c and contacts the interior bottom surface 311c of the void 302c, forcing pin 304c upward a displacement distance. The depth of void 302c is Z₃. The displacement distance of the pin is translated through linkage 305c to control the metering valve 310c. In this case, the flow metering valve 310c is configured to be partially open as illustrated in FIG. 4B. Flowrate Q₃ is delivered through the flow metering valve 310c.

As seen in FIG. 4C, a third beverage tablet 301d contains a void 302d. Contact pin 304d of a beverage machine enters void 302d and contacts the bottom interior surface 311d of the void 302d, forcing pin 304d upward a displacement distance greater than that of FIG. 4B. The depth of void 302d is Z₄. The displacement distance of the pin is translated through linkage 305d to control the metering valve 310d. In this case, the flow metering valve 310d is configured to be fully open as illustrated in the figure. Flowrate Q₄ is delivered through the flow metering valve 310d, Q₄ is the maximum flow rate capable of being delivered through the valve under these conditions. In some embodiments, the maximum flow rate may be delivered by the contact pin contacting the surface of the tablet in a location without a void, e.g. in the configuration where shallow voids indicate higher flowrates a solid surface with no void may be configured to give the maximum flow rate. While the foregoing example shown in FIGS. 4A-4C correlated deeper voids with lower flow rates, the opposite configuration is also contemplated, and this disclosure is not to be limiting in that way.

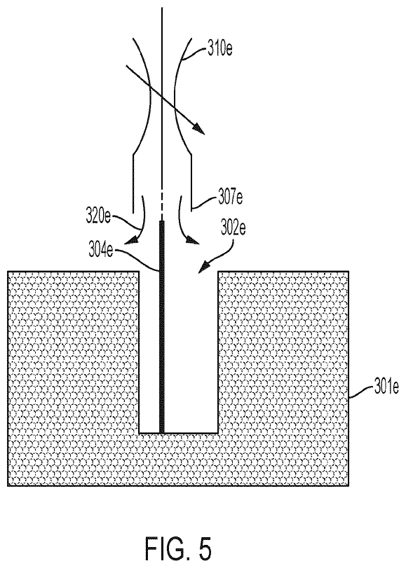

FIG. 5 illustrates one embodiment of the contact pin and flow metering valve such as envisioned conceptually in FIG. 3. In the illustrated embodiment, the contact pin 304e enters void 302e in tablet 301e. The upstream end of the contact pin 304e is integral with the linkage and forms part of flow metering valve 310e. Fluid would be provided to the valve from the top in the orientation illustrated. The contact pin may include a needle or slider which sets the flow area of valve 310e such that the contact pin forms part of the valve. Fluid exits fluid port 307e which surrounds the contact pin 304e such that the contact pin is partially located within the fluid port. The contact pin moves longitudinally with respect to the fluid port, the location of the fluid port being fixed in relation to the brew chamber.

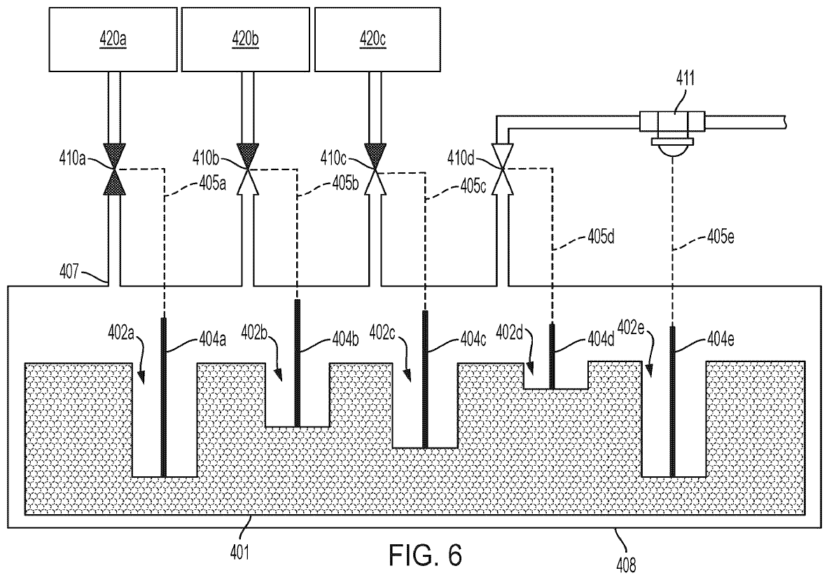

FIG. 6 shows a representation of a beverage tablet with several voids which may change physical configurations of several valves of a beverage machine. The example shown is for illustrative purposes only and elements from FIG. 6 may be used separately or combined in different combinations including in combination with other aspects described in this disclosure. Beverage tablet 401 is shown positioned within a brew chamber 408 of a beverage machine. Voids 402a-402e are disposed on the upper surface of tablet 401. Contact pins 404a-e line up with and enter their respective voids 402a-e. The first valve 410a on the left is operably coupled to contact pin 404a. As with the example in FIG. 4A, the void 402a is too deep to bottom out the contact pin 404a, and hence the valve 410a remains closed. The flow from each flow metering valve enters the brew chamber at a fluid port 407. The fluid port location may be other than through or around the contact pin, for example fluid port location 407 for the leftmost connection. Flow may be routed to enter the brew chamber in any suitable location.

Valves 410a-c are respectively in fluid communication with fluid sources 420a-c. The fluid sources may be separate sources or the same source, and may be the same fluid or different fluids. The temperature and pressure may likewise be different in sources 420a, 420b and 420c. By combination of different flow rates from the three fluid sources, conditions may be adjusted within the brew chamber may be set by combining flow from each source in the desired proportion. For instance, valves 410b and 410c are partially open, as set by the locations of contact pins 404b and 404c the motion being conveyed by linkages 405b and 405c, respectively. The temperature of source 420b may be T1 and the temperature of source 420c may be T2. A brew chamber temperature between T1 and T2 may be achieved by admitting the desired quantity of fluid from each source 420b and 420c. Likewise, the fluid sources may have different fluids or different pressures as appropriate to achieve desired brew chamber conditions or composition. In some embodiments, the fluid will be liquid water. In some embodiments, the fluid may be steam or air. In some embodiments, steam or air may be injected into the brew chamber in a different way than liquid water, for instance to froth or aerate the beverage. Other fluids are also contemplated. The fluid ports may be configured differently for different fluids, for instance fluid ports for liquid water may be located in or around the contact pins and fluid ports for air or steam may be located in different locations, such as near the outlet of the brew chamber such as for aeration of the beverage etc.

In FIG. 6, the rightmost void 402e is seen to locate contact pin 404e. Pin 404e is connected to adjust a mechanical pressure regulator 411 by a linkage 405e. The mechanical pressure regulator controls the pressure in a fluid line connected to valve 410d. The pressure regulator may be a diaphragm-type pressure regulator or any other type of mechanically operated pressure regulating device. The position of valve 410d may be set by contact pin 404d and linkage 405d acting on void 402d. In this way, the pressure in the brew chamber may be controlled by mechanical devices in response to the depth of the voids of the beverage tablet. It should be noted that a pressure regulator is one form of fluid metering valve configured to meter flow so as to achieve a certain pressure at a certain position, (e.g., the outlet side of the regulator). Other fluid metering valves may include thermostatic valves or positive displacement flow controls.

While some embodiments would control brew chamber conditions by regulating inflow to the brew chamber, it is contemplated that outflow from the brew chamber may be regulated by flow control valves or pressure regulators that are set by the interaction of one or more contact pins with voids on the tablet of beverage material as disclosed for inflow to the brew chamber. This disclosure is not the be limiting to the direction of flow through any valve.

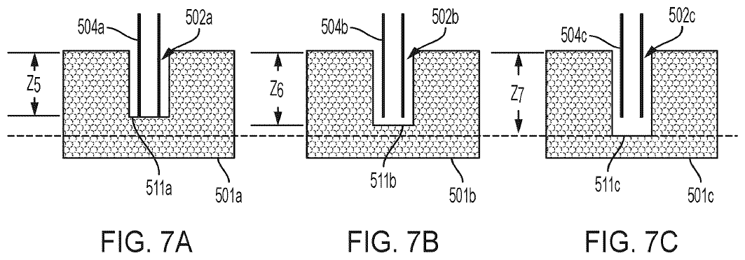

FIGS. 7A-7C illustrate three beverage tablets, each having a different void depth, and each interacting with a beverage machine. In these embodiments, conduit-type contact pins 504a, 504b, and 504c are in the form of conduits, such as tubes, entering voids 502a, 502b, and 502c respectively in the tablet of beverage material. In the embodiments shown, the flow controlling valve is formed by the combination of the conduit end and the void itself. For instance, in the FIG. 7A arrangement, a conduit-type contact pin 504a is held against the interior bottom surface 511a of void 502a, effectively blocking the end of the conduit 504a from which fluid would otherwise discharge. Void 502b of FIG. 7B is deeper than void 502a of FIG. 7A, allowing fluid to pass from the end of the conduit. Void 502c of FIG. 7C is deeper still, and would result in a larger flow area and potentially a larger flow rate than from conduit 504b, all other parameters being equal. In this way, some embodiments may affect or control flow rate by controlling flow directly through the interaction of the beverage material and beverage machine. It may be observed that the flow rates may change during the brewing process as the tablet of beverage material may be ablated by the flow.

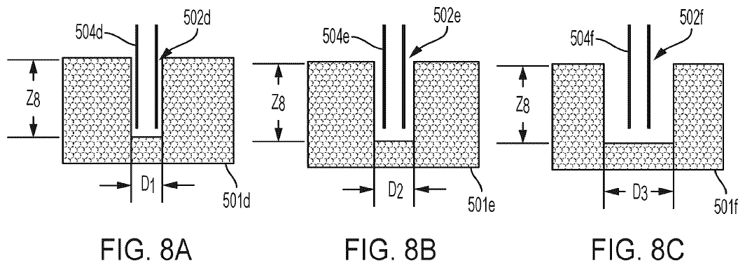

FIGS. 8A-8C show an alternative embodiment in which the diameters D₁, D₂ and D₃ of voids 502d, 502e and 502f respectively are varied rather than the depth of the voids, although in other embodiments, depth could be simultaneously increased with increasing void diameter. Similar to the principle shown in FIGS. 7A-7C, the extent of the void diameter may alter the flow area between the discharge from a contact pin in the form of a conduit and the beverage tablet material itself, thereby creating a valve to affect flowrate. It should be appreciated that embodiments such as illustrated in FIGS. 7A-C and 8A-8C would tend to increase flow rate with increasing void depth.

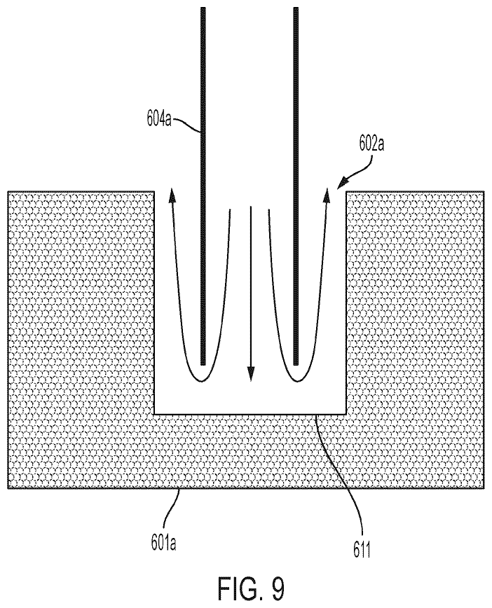

The discharge end of a conduit version of a contact pin carrying flow is illustrated in FIG. 9. Void 602a in a portion of tablet 601a receives a contact pin in the form of a conduit 604a. Flow discharges from the bottom end of the conduit 604a. If the conduit 604a is used to control a flow metering valve as in FIGS. 3, 4A-C and 6, the bottom surface of conduit will be blocked by contact between the end of the conduit and the interior bottom surface 611 of the void 602a, which may affect the ability of the flow metering valve to control flow.

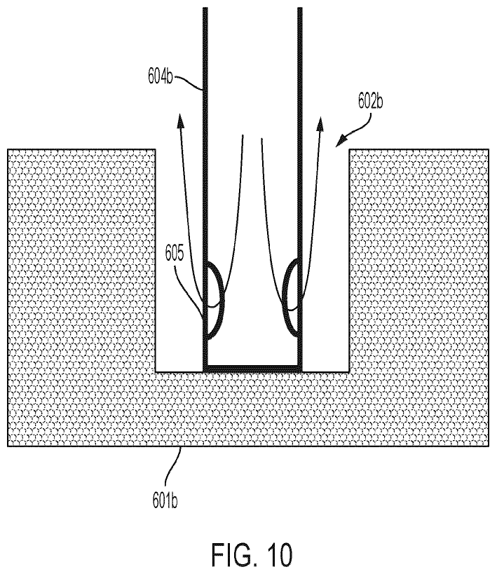

In the embodiment of FIG. 10, a contact pin in the form of a conduit 604b allows fluid a path out of the conduit 604b. Void 602b in a portion of tablet 601b receives conduit 604b. Flow discharges from holes 605 disposed along the sides of the of the conduit and the holes not impeded by the bottom of void 602b. This may be combined with the void bore diameters as illustrated in FIG. 8 such as to further affect the flowrate or to increase velocity, create turbulence, etc. which may be beneficial to the brewing process.

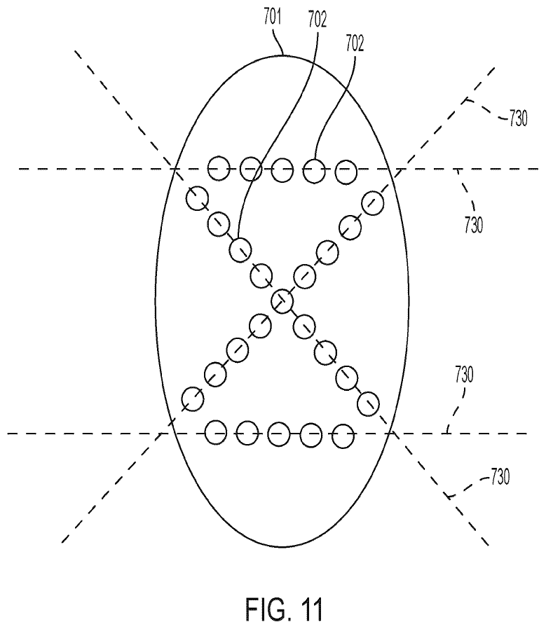

In some embodiments, voids on the tablet may act as perforations to facilitate the breakage of the beverage tablet according to a regular and predictable way. FIG. 11 shows a beverage tablet 701 containing a plurality of voids 702. As illustrated, the voids 702 will facilitate the beverage tablet breaking along lines 730, in this example forming six primary pieces. These primary pieces may be of approximately equal size. The pattern and number of voids are shown for illustrative purposes only and other arrangements are contemplated. Likewise, it may be advantageous to break the beverage tablet into more than six primary pieces, for instance at least eight or at least twelve primary pieces may be desirable.

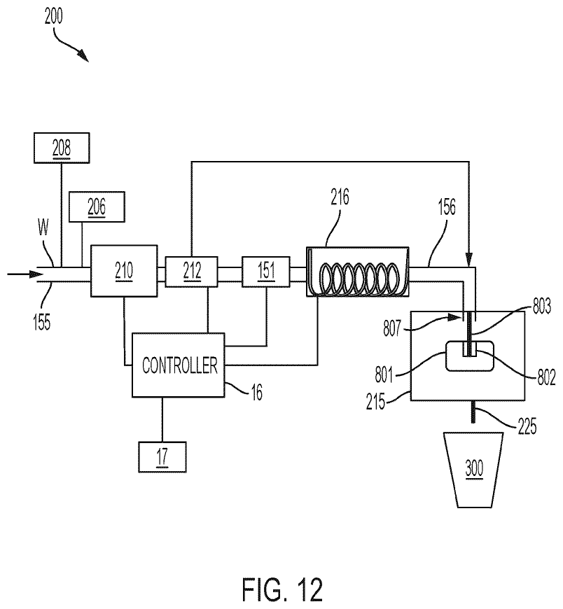

FIG. 12 shows a schematic block diagram of various components that may be included in a beverage machine 200 in one illustrative embodiment. Those of skill in the art will appreciate that a beverage machine 200 may be configured in a variety of different ways, and thus aspects of the invention should not be narrowly interpreted as relating only to one type of beverage machine. In this embodiment, a precursor liquid (e.g. hot or cold water) may be supplied from a liquid supply (e.g. a water reservoir) to a brew chamber 215. A beverage ingredient tablet 801 comprising one or more beverage ingredients (e.g. coffee grounds, soluble coffee, tea leaves, etc.) may be included for use in forming the beverage. The 801 may comprise a compacted beverage tablet in which its beverage ingredients 211 have been compacted into a tablet form.

A liquid supply W may supply beverage precursor liquid to a brew chamber 215. The source W may have any suitable arrangement, e.g., may provide liquid from a removable or fixed storage tank, a mains water supply or other source. Thus, in some cases, the liquid provided from the source W may vary in temperature by a wide degree depending on various factors, such as time of year, a temperature of a room in which the beverage machine 200 is located, etc. For example, if the source W is a reservoir that is filled by a user, the temperature of liquid in the reservoir may vary between room temperature (e.g., if liquid sits in the reservoir for an extended time) and a cooler temperature (e.g., if the reservoir has just been filled with water that is dispensed from a tap).

A pump 210 may drive liquid from the liquid supply W through a valve 151 through a liquid conditioner 216 (e.g. a heater, chiller, and/or carbonator), into a supply line 156 through a fluid port 807 and into the brew chamber 215 where a beverage tablet 801 is held. A contact pin 803 of the beverage machine physically interacts with a void 802 of the beverage tablet 801. As described above, the depth of the void 802 determines a displacement distance of the contact pin 803, which in turn mechanically sets a flow rate out of the fluid port 807.

Following introduction of beverage precursor liquid into the brew chamber 215, the beverage tablet 801 may be mixed with the precursor liquid to form a desired beverage. The beverage may then be dispensed to a container 300 (e.g., a cup or a carafe) using a beverage machine dispenser outlet 225.

The pump 210 and/or valve 151 may be in electrical communication with a controller 16 and/or a user interface. In some embodiments, the pump 210 may serve as the sole fluid driving source that moves liquid from the liquid supply W to the brew chamber 215.

In some embodiments, an air valve 208 may be provided between the liquid supply W and the pump 210. The air valve 208 may allow air trapped within the liquid line 155 to escape the flow path prior to entering the pump 210. This may contribute to more efficient operation of the pump 210 and any downstream components, or reduce a likelihood of damage to the pump 210 or any downstream components. The air valve 208 may be in electrical communication with the controller 16 and/or a user interface.

In some embodiments, a pressure relief valve 212 may be provided between the pump 210 and the valve 151. The pressure relief valve 212 may allow liquid from the pump 210 to bypass the valve 151 in the event that excess pressure builds between the pump 210 and the valve 151. Liquid from the pressure relief valve 212 may be allowed to exit the beverage machine 200 through the brew chamber 215, or any other appropriate outlet of the machine. In this way, the pressure relief valve 212 may prevent a build-up of excess pressure between the pump 210 and the valve 151. This configuration may prevent damage to the pump 210, the valve 151, and/or other system components, particularly in the event that the valve 151 or another downstream component becomes blocked or clogged.

In some embodiments, a liquid level detector 206 may be provided in the beverage machine 200 near the liquid supply W, or in some embodiments, in the liquid supply W itself. In some embodiments, the liquid level detector may be a conductivity probe positioned near an outlet of the liquid supply W. The liquid level detector may sense when the liquid in the liquid supply W is below a threshold fill level, such as when the liquid supply is empty or nearly empty. In other embodiments, the liquid level detector may include a microswitch with an attached float that rises with liquid level in a tank of the liquid supply W. In another embodiment, the liquid level detector may detect a capacitance change associated with one or more liquid levels in the tank, may use an optical emitter/sensor arrangement (such as an LED and photodiode) to detect a change in liquid level, may use a pressure sensor, may use a floating magnet and Hall effect sensor to detect a level change, and others. Thus, the liquid level detector is not necessarily limited to a conductive probe configuration. Moreover, the liquid level detector may include two or more different types of sensors to detect different levels in a tank of a liquid supply. For example, a pressure sensor may be used to detect liquid at a first dispense level, while a conductive probe may be used to detect liquid at a second, different dispense level. The liquid level detector 206 may be in electrical communication with the controller 16 and/or a user interface.

In some embodiments, the liquid conditioner 216 is a heater comprising any appropriate type of heater, boiler, or heat exchanger. For example, in some embodiments, the liquid conditioner 216 may be a flow-through heater that has a relatively small volume, e.g., a tube with associated heating element to heat liquid in the tube. Examples of flow-through heaters include a flat flow through heater, a spiral flow through heater, a U-shaped flow through heater, or any other type of heater. In some embodiments, the heater may be a heating element that heats a hot water tank. The heater may be in thermal communication with the hot water tank, e.g. inside the hot water tank in direct contact with the water inside the tank, or in a non-water contact arrangement in which the heater is provided outside the tank or embedded within the tank wall. The liquid conditioner 216 may be in electrical communication with the controller 16 and/or a user interface.

Of course, heating of the liquid is not necessary, and instead (or additionally) the liquid conditioner may comprise a chiller to cool the liquid, a carbonator to carbonate the liquid, or otherwise condition the liquid in a way that alters the volume of liquid supplied to the brew chamber.

The controller 16 may include a programmed processor and/or other data processing device along with suitable software or other operating instructions, one or more memories (including non-transient storage media that may store software and/or other operating instructions), temperature and liquid level sensors, pressure sensors, input/output interfaces (such as a user interface 17), communication buses or other links, a display, switches, relays, triacs, or other components necessary to perform desired input/output or other functions. A user interface 17 may be included to provide information to a user and/or receive information from a user, such as buttons, a touch screen, a voice command module (including a microphone to receive audio information from a user and suitable software to interpret the audio information as a voice command), a visual display, one or more indicator lights, a speaker, and so on.

It should be appreciated that the use of directional terms such as up/down, upper/lower, left/right etc in context to the figure descriptions may represent the position as indicated in the figure as drawn but should not be taken to exclude the possibility of other orientations. These directional terms may not be with respect to a user's frame of reference.

Various aspects of the present disclosure may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A beverage machine, comprising:
a brew chamber configured to receive a beverage tablet comprising beverage ingredients;
at least one contact pin, wherein the at least one contact pin is configured to physically contact the beverage tablet, and wherein the at least one contact pin is moveable relative to the brew chamber such that contact between the contact pin and the tablet causes the at least one contact pin to move a displacement distance relative to the brew chamber; and
at least one fluid port configured to introduce fluid from a liquid supply into the brew chamber,
wherein the displacement distance moved by the at least one contact pin due to contact between the at least one contact pin and the beverage tablet mechanically sets a fluid flow rate from the at least one fluid port.

2. The beverage machine of claim 1, wherein the contact pin and the fluid port are separate pieces.

3. The beverage machine of claim 1, wherein the at least one contact pin is part of the fluid port.

4. The beverage machine of claim 3, wherein at least a portion of the contact pin is positioned within the fluid port, the contact pin being moveable relative to the fluid port.

5. The beverage machine of claim 3, wherein at least one fluid port is located within the at least one contact pin.

6. The beverage machine of claim 3, wherein the fluid port comprises at least one opening disposed along a surface of the at least one contact pin.

7. The beverage machine of claim 1, wherein the at least one contact pin is configured to lock into position after contacting the tablet of beverage material.

8. The beverage machine of claim 1, wherein a flowrate through at least one fluid port is proportional to the displacement distance of the at least one contact pin.

9. The beverage machine of claim 1, further comprising a second contact pin configured to physically contact the beverage tablet.

10. The beverage machine of claim 1, wherein a flowrate through the at least one fluid port is determined by a flow area, the flow area being mechanically set by an interaction of the contact pin and the tablet of beverage material.

11. The beverage machine of claim 1, further comprising a second fluid port, wherein a fluid temperature supplied from the fluid port differs from a fluid temperature supplied from the second fluid port.

12. The beverage machine of claim 1, wherein at least one contact pin is configured to fracture the tablet.

13. The beverage machine of claim 1, wherein an input from a user determines a number of contact pins that are configured to contact the tablet.

14. The beverage machine of claim 1, wherein an input from a user configures the beverage machine to break the tablet.

15. The beverage machine of claim 1, wherein the fluids admitted to the brew chamber include at least one of liquid water, steam, air.

16. The beverage machine of claim 1, wherein increasing the displacement distance of the contact pin mechanically causes the fluid flow rate from the at least one fluid port to increase.

17. The beverage machine of claim 1, wherein increasing the displacement distance of the contact pin mechanically causes the fluid flow rate from the at least one fluid port to decrease.

18. The beverage machine of claim 1, wherein the brew chamber comprises a brew chamber lid, wherein the at least one contact pin is coupled to the brew chamber lid.

19. The beverage machine of claim 1, wherein the brew chamber comprises a brew chamber receptacle, wherein the at least one contact pin is coupled to the brew chamber receptacle.

20. The beverage machine of claim 1, wherein the beverage machine further comprises at least one fluid metering valve, and
wherein the fluid flow rate from the at least one fluid port is mechanically set by mechanical interaction between the beverage tablet, the at least one contact pin, and the at least one fluid metering valve.

21. The beverage machine of claim 1, further comprising a controller, wherein the fluid flow rate from the at least one fluid port is mechanically set without involvement from the controller.

22. A beverage tablet comprising:
a first end of the beverage tablet;
a second end of the beverage tablet displaced by the first end by a thickness; and
a blind hole having a depth extending from the first end of the beverage tablet toward the second end of the beverage tablet only partially through the thickness, the blind hole having an interior contact surface configured to abut against a contact pin of a beverage machine.

23-30. (canceled)

31. A beverage forming arrangement comprising:
a beverage machine; and
a beverage tablet comprising a blind hole having a depth extending only partially through a thickness of the beverage tablet, the blind hole having an interior contact surface configured to abut against a contact pin of the beverage machine, wherein the depth of the blind hole determines a displacement distance of the contact pin during abutment of the interior contact surface against the contact pin,
wherein the displacement distance moved by the contact pin mechanically sets a fluid flow rate from at least one fluid port of the beverage machine.

32-38. (canceled)

39. A method of forming a beverage comprising:
inserting a beverage tablet into a beverage machine;
bringing at least one contact pin of the beverage machine into contact with the beverage tablet, causing the at least one contact pin to move a displacement distance due to contact with the beverage tablet, wherein the displacement distance moved by the at least one contact pin mechanically sets a fluid flow rate from at least one fluid port of the beverage machine; and
actuating the beverage machine to output liquid through the at least one fluid port at the fluid flow rate into contact with the beverage machine to form a beverage.

40-46. (canceled)
